(19) United States
(12) Patent Application Publication
(10) Pub. No.: US 2026/0081051 A1
(43) Pub. Date: Mar. 19, 2026

(54) HYBRID CERAMIC POLYMER INSULATOR

(71) Applicant: Preformed Line Products Company, Cleveland, OH (US)

(72) Inventors: Benjamin Franklin Ciesielczyk, Madison, OH (US); Douglas Bell, Cleveland, OH (US)

(21) Appl. No.: 18/889,535

(22) Filed: Sep. 19, 2024

(51) Int. Cl. H01B 3/08; H01B 3/12; H01B 3/30; H02G 7/20

(52) U.S. Cl. CPC H01B 3/084; H01B 3/12; H01B 3/30; H02G 7/20

(57) ABSTRACT

An insulator that supports a line from a pin includes a core that defines an opening configured to receive the pin, and includes a shell formed from a polymer disposed over an outer surface of the core. The insulator also includes a head formed from the core or the shell, and configured to support the line spaced from the pin.

### BACKGROUND

Insulators are often essential components in power distribution systems that provide mechanical support and electrical isolation for conductors that carry high-voltage electricity. In overhead power lines, for example, distribution insulators are specifically designed to support the weight of power conductors while preventing electrical leakage from the conductors to supporting structures, such as utility poles or towers.

Traditional distribution insulators are often entirely made from materials such as porcelain, glass, or polymers, which exhibit favorable dielectric strength and mechanical durability. Such materials are selected for their ability to resist environmental degradation from factors such as moisture, pollution, and temperature fluctuations. However, the evolving demands of modern power grids, combined with environmental concerns and advancements in material science, have highlighted certain limitations in existing insulator designs.

A limitation of current designs is the mechanical stress that insulators experience due to wind, ice accumulation, and mechanical loading from the weight of power conductors. Over time, these stresses can lead to material fatigue, compromising the insulator's performance and reliability. This problem is particularly prevalent in areas with harsh climates or high seismic activity, where insulators are subjected to extreme environmental conditions. Notably, ceramic insulators may be particularly susceptible to damage as compared to polymer insulators in environments characterized by high mechanical loading.

Another limitation of current designs is thermal loading that occurs when, for example, an insulator is struck by lightning. In such events, thermal loading may burn or melt through material forming the insulator, causing structural failure. Notably, polymer insulators may be particularly susceptible to damage as compared to ceramic insulators in environments characterized by high thermal or electrical loading.

### BRIEF DESCRIPTION

According to one aspect, an insulator that supports a line from a pin includes a core that defines an opening configured to receive the pin, and includes a shell formed from a polymer disposed over an outer surface of the core. The insulator also includes a head formed from the core or the shell, and configured to support the line spaced from the pin.

According to another aspect, an insulator that supports a line from a pin includes a core that defines an opening configured for receiving the pin, and includes a shell overmolded upon an outer surface of the core. The insulator also includes a head formed from the core and the shell, wherein the core defines a saddle that is concave toward the opening and configured to directly contact and support the line spaced from the pin.

According to another aspect, a method of manufacturing an insulator that supports a line from a pin includes forming a core from a ceramic, a glass, a first polymer, or a second polymer. The core is formed to include a wall that extends in a longitudinal direction of the insulator and defines a threaded opening configured for engaging the pin in a thread fit. The method also includes overmolding a shell upon the core, where the shell is formed from the first polymer, and the core or the shell form a head configured to support the line spaced from the pin in the longitudinal direction.

The innovation described herein describes an insulator that, among other features, offers an improved combination of material and structural properties for withstanding thermal loading, electrical loading, and mechanical loading. In addition to other described features, functions, and benefits, the insulator described herein may reliably support and secure a line within a compact space.

### BRIEF DESCRIPTION OF THE DRAWINGS

FIG. 1 is a perspective view of an example insulator in accordance with aspects of the innovation.

FIG. 2 is a cross-sectional view of the insulator of FIG. 1, including a shell and a core.

FIG. 3 is a perspective view of the core included in the insulator of FIG. 1.

FIG. 4 is a perspective view of an insulator that is an alternative embodiment to the insulator of FIG. 1, in accordance with aspects of the innovation.

FIG. 5 is a cross-sectional view of the insulator of FIG. 4 including a shell and a core.

FIG. 6 is a perspective view of the core included in the insulator of FIG. 4.

FIG. 7 is an example method of manufacturing an insulator configured to embody one or more of the provisions set forth herein, according to one aspect.

### DETAILED DESCRIPTION

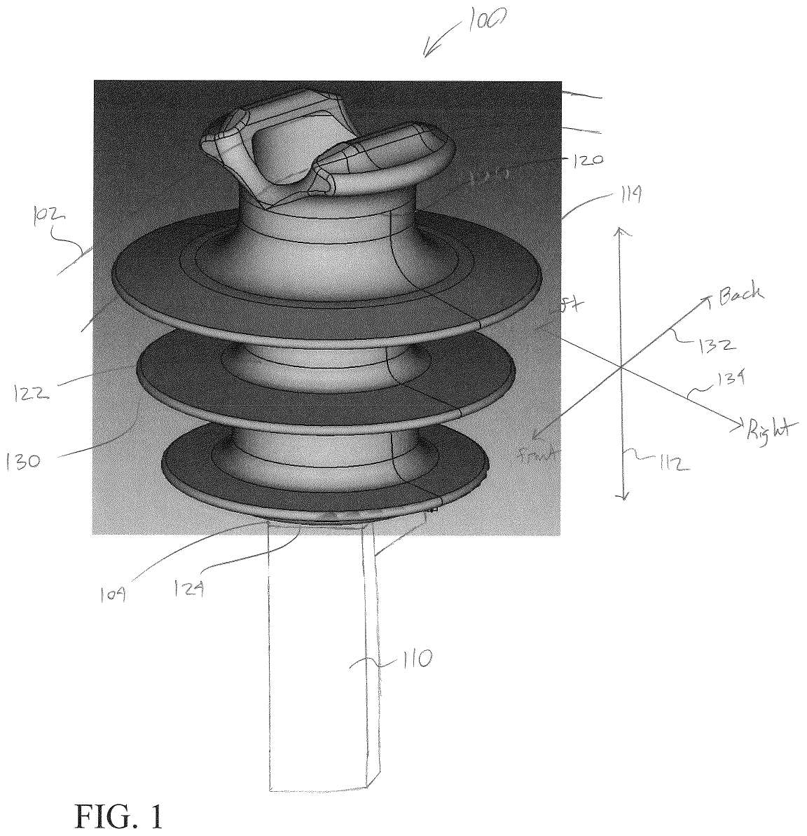

It should, of course, be understood that the description and drawings herein are merely illustrative and that various modifications and changes can be made in the structures disclosed without departing from spirit and scope of the subject disclosure. Referring now to the drawings, wherein like numerals refer to like parts throughout the several views, in accordance with an aspect of the innovation, FIG. 1 depicts an insulator 100 that supports a line 102 from a pin 104 mounted onto a utility pole 110. The insulator 100 receives the pin 104 and supports the line 102 spaced from the pin 104 such that the insulator is interposed between and separates the pin 104 and the utility pole 110 from the line 102. The insulator 100 supports the line 102 from the pin 104 in a longitudinal direction of the insulator 100, indicated by an arrow 112. As depicted in FIG. 1, the longitudinal direction of the insulator 100 is a vertical direction when the insulator 100 is in an upright position.

The insulator 100 includes a shell 114 that forms a head 120, a main body portion 122, and a skirt 124. The head 120 directly contacts and supports the line 102 above the pin 104 in the longitudinal direction of the insulator 100. The main body portion 122 is interposed between and separates the head 120 and the skirt 124 in the longitudinal direction of the insulator 100.

The insulator 100 receives the pin 104 to a position where the skirt 124 supports the main body portion 122 and the head 120 on the utility pole 110 in the longitudinal direction of the insulator 100. In this regard, the skirt 124 extends downward from the main body portion 122 in the longitudinal direction of the insulator 100, spacing the main body portion 122 and the head 120 from the utility pole 110 in the longitudinal direction. With this construction, mechanical and electrical loading from the line 102 toward the pin 104 and the utility pole 110 may be directed through an interface between the skirt 124 and the utility pole 110.

The shell 114 also forms sheds 130 that extend outward from the main body portion 122 in a front-back direction of the insulator 100 perpendicular to the longitudinal direction, indicated by an arrow 132. The sheds 130 also extend in a left-right direction of the insulator 100 perpendicular to the longitudinal direction, indicated by an arrow 134. In this regard, each of the sheds 130 are plates that extend radially outward from the insulator 100 perpendicular to the longitudinal direction of the insulator 100, and are rounded about the longitudinal direction.

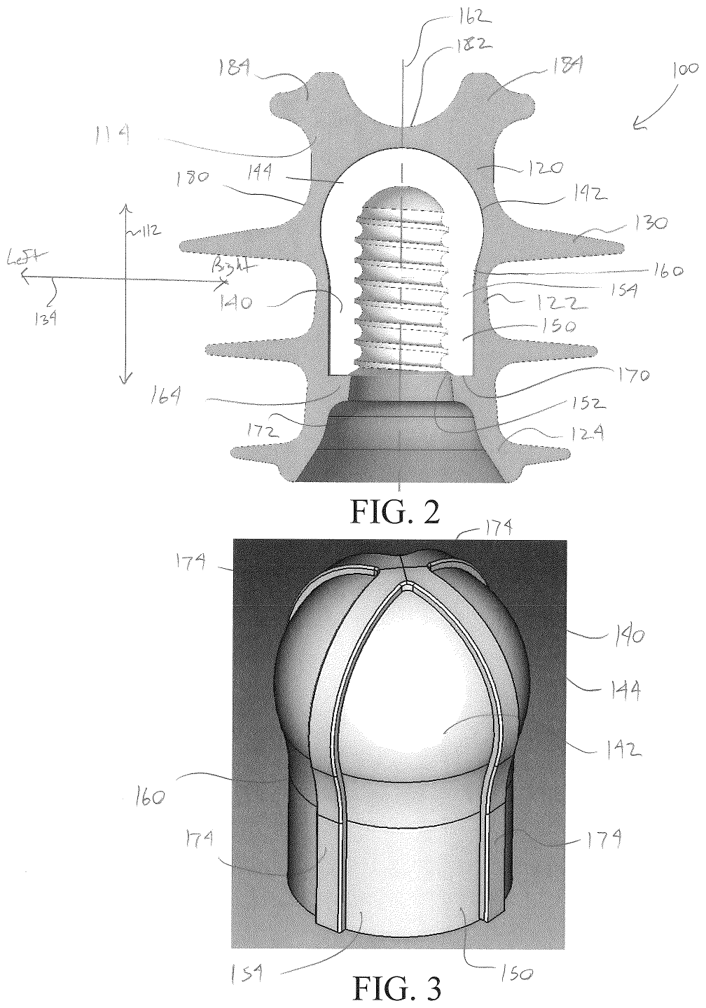

FIG. 2 depicts a cross-sectional front view of the insulator 100. As shown in FIG. 2, the insulator 100 includes a core 140, where the shell 114 is disposed over an outer surface 142 of the core 140.

The shell 114 is formed from a polymer, such as a silicone rubber, an epoxy resin, a polyester resin, a vinyl ester epoxy blend, or an ethylene propylene diene monomer. In an embodiment, the core 140 is formed from a same polymer as the shell 114, with the core 140 and the shell 114 being cured at different times. With this construction, as depicted, each of the core 140 and the shell 114 may be respectively formed with approximately constant thicknesses that minimize warping or uneven curing in an associated manufacturing assembly.

In an alternative embodiment, the core 140 is formed from an inorganic nonmetal. In a further embodiment, the inorganic nonmetal includes porcelain, ball clay, or tempered glass. As such, material properties of the core 140 may feature increased electrical resistance, mechanical rigidity, and resistance to thermal loading as compared to the shell 114. With this construction, the core 140 may feature relatively increased electrical insulation, mechanical rigidity, and resistance to thermal loading as compared to the shell 114. Also, the shell 114 may feature a lower modulus of elasticity, a higher material strength in elastic or plastic deformation ranges, or a higher ultimate tensile strength as compared to the core 140.

In an alternative embodiment, the polymer that forms the shell 114 is a first polymer, and the core 140 is formed from a second polymer that is a dielectric material different from the first polymer. In the embodiment, the first polymer has a lower modulus of elasticity, a higher material strength, or a higher ultimate tensile strength. Also, the second polymer may feature a higher hardness rating, a higher electrical resistance, or a higher heat resistance.

With this construction, the insulator 100 as a whole features increased electrical insulation from the line 102 to the pin 104 along a path through the shell 114 and the core 140 as compared to the core 140 being formed from the same polymer as the shell 114. The core 140 may also feature an increased heat tolerance or thermal load resistance as compared to the shell 114. With this construction, the insulator 100 may inhibit or otherwise withstand thermal loading, such as that generated in a lightning strike, from burning or melting through the core 140. Also, the insulator 100 at the shell 114 may feature higher mechanical impact or wear resistance as compared to the shell 114 being formed from ceramic.

With continued reference to FIG. 2, the core 140 includes a first end portion 144 that forms the head 120 with the shell 114 to support the line 102 spaced from the pin 104. The core 140 also includes a second end portion 150 extended downward from the first end portion 144, into and through the main body portion 122 of the shell 114 in the longitudinal direction of the insulator 100. The shell 114 encases the entire first end portion 144 of the core 140 along the outer surface 142, and encases the second end portion 150 of the core 140 along the outer surface 142 in the front-back direction and the left-right direction of the insulator 100. As such, the shell 114 is disposed entirely over the core 140 in the longitudinal direction of the insulator 100, and is disposed entirely around the core 140 perpendicular to the longitudinal direction. Notably, the encased portions of the core 140 are directly protected from fall damage, and other impact or environmental damage by the shell 114.

The second end portion 150 of the core 140 defines an opening 152 with a wall 154 extended upward toward the head 120, to the first end portion 144 in the longitudinal direction of the insulator 100. The opening 152 is configured to receive the pin 104 such that the core 140 fixes the insulator 100 to the utility pole 110 through the second end portion 150 via the pin 104. In this regard, the opening 152 is threaded and configured to directly contact the pin 104 in a thread fit for fixing the core 140 and the shell 114 with the pin 104. With this construction, mechanical, electrical, and thermal loading from the line 102 to the pin 104 and the utility pole 110 may be directed through an interface between the core 140 and the pin 104.

The first end portion 144 is larger than the second end portion 150 in the front-back direction and the left-right direction of the insulator 100. The outer surface 142 of the core 140 at the first end portion 144 is spheroidal, and an edge 160 between the first end portion 144 and the second end portion 150 is rounded.

Also, the outer surface 142 of the core 140 at the second end portion 150 is rounded about the longitudinal direction of the insulator 100. More specifically, the wall 154 in the second end portion 150 is cylindrical and defines a centerline 162 in the longitudinal direction of the insulator 100 that intersects the outer surface 142 of the core 140 at the first end portion 144. As such, the first end portion 144 of the core 140 is a bulb that defines the outer surface 142 of the core 140 as spheroidal, and the second end portion 150 is a stem that defines the outer surface 142 as rounded about the longitudinal direction of the insulator 100, and extended from the bulb in the longitudinal direction.

With continued reference to FIG. 2, the shell 114 includes a lip 164 extended along the wall 154 in a direction perpendicular to the longitudinal direction of the insulator 100, where the lip 164 abuts a bottom end portion 170 of the wall 154 at the opening 152 in the longitudinal direction. More specifically, the lip 164 extends radially inward from the main body portion 122, toward the wall 154, perpendicular to the longitudinal direction of the insulator 100. With this construction, the lip 164 supports the core 140 in the shell 114, in the longitudinal direction of the insulator 100 from the bottom end portion 170 of the wall 154.

The lip 164 extends along a circumference of the opening 152, and defines hole 172 concentric with the opening 152 with respect to the longitudinal direction of the insulator 100. The hole 172 has a width larger than the opening 152. As such, the lip 164 is configured for receiving the pin 104 in the hole 172 with a clearance around the pin 104 when the core 140 engages the pin 104. With this construction, the lip 164 supports the core 140 in the shell 114 without obstructing the pin 104 received in the opening 152.

The shell 114 is overmolded upon the core 140. As such, the shell 114 is disposed over the first end portion 144 and the second end portion 150 of the core 140 along the outer surface 142.

FIG. 3 depicts a perspective view of the core 140. As shown in FIG. 3, the core 140 includes protrusions 174 that extend along the outer surface 142 of the core 140 in the longitudinal direction of the insulator 100. The protrusions 174 also extend radially outward from the outer surface 142 at the first end portion 144 and the second end portion 150, and into the shell 114 in a direction perpendicular to the longitudinal direction of the insulator 100.

The protrusions 174 are spaced from each other with a regular angular offset in a circumferential direction around the core 140 at the second end portion 150, about the longitudinal direction of the insulator 100. The protrusions 174 also connect with each other at the first end portion 144, at a side of the core 140 opposite the opening 152. With this construction, the shell 114 is interposed between consecutive protrusions 174 in the circumferential direction of the core 140, such that the outer surface 142 of the core 140 is fixed with the shell 114 and prevented from rotating in the circumferential direction relative to the shell 114. While, as depicted, the core 140 includes four of the protrusions 174, the core 140 may include more or fewer of the protrusions 174 without departing from the scope of the subject disclosure.

Referring back to FIG. 2, the portions of the shell 114 forming the head 120, the main body portion 122, the skirt 124, and the sheds 130 feature a same approximate thickness. As such, the shell 114 may be overmolded upon the core 140 with minimal warping or uneven curing. While, as depicted, the shell 114 is a single polymer body overmolded directly upon the outer surface 142 of the core 140, the shell 114 may additionally or alternatively include a sleeve disposed over the outer surface 142 without departing from the scope of the subject disclosure. In this regard, the shell 114 may include a sleeve having a constant wall thickness disposed along the core 140 from the head 120 at the first end portion 144 to the opening 152 at the second end portion 150. Further, the shell 114 may be formed from a plurality of sleeves or overmolded layers successively disposed over the core 140.

The core 140 forms most of the insulator 100 at and above the bottom end portion 170 of the wall 154 with respect to material volume. In this regard, a thickness of the wall 154 in the first end portion 144 and the second end portion 150 is greater than a thickness of the shell 114 at the wall 154 in a direction perpendicular to the longitudinal direction of the insulator 100.

The skirt 124 extends downward from the main body portion 122, away from the wall 154 and the head 120 in the longitudinal direction of the insulator 100. The skirt 124 also extends radially outward from the core 140, in the front-back direction and the left-right direction of the insulator 100. As such, the skirt 124 extends with an incline downward and outward from the core 140 and the main body portion 122 with respect to the longitudinal direction of the insulator 100. With this construction, the skirt 124 is configured to receive the pin 104 such that the pin 104 engages the opening 152 in reliable assembly without obstruction at the skirt 124. Also, the skirt 124 is configured to support the shell 114 and the core 140 on the utility pole 110 against vertical and lateral mechanical loading between the utility pole 110 and the line 102.

The shell 114 forms an exterior surface 180 of the insulator 100 at the head 120, the main body portion 122, and the skirt 124. As depicted, the shell 114 forms the head 120 with the exterior surface 180 defining a saddle 182 that is concave toward the opening 152 and configured for directly contacting and supporting the line 102 spaced from the pin 104 in the longitudinal direction of the insulator 100. The saddle 182 extends perpendicular to the longitudinal direction of the insulator 100, in the front-back direction, and receives the line 102 in the front-back direction.

The shell 114 forms guards 184 at opposite sides of the head 120 in the left-right direction of the insulator 100. The guards 184 each extend upward from the main body portion 122, beyond the saddle 182 in the longitudinal direction of the insulator 100. The guards 184 also extend outward from the main body portion 122 in the left-right direction of the insulator 100. With this construction, the guards 184 are configured to retain the line 102 in the saddle 182 with respect to the left-right direction of the insulator 100, and shield the line 102 from objects outside the saddle 182, without obstructing the line 102 from being laid across the saddle 182.

With continued reference to FIG. 2, the sheds 130 extend outward from each of the guards 184, the main body portion 122, and the skirt 124 in the front-back direction and the left-right direction of the insulator 100. In this regard, the sheds 130 extend outward along the exterior surface 180 of the insulator 100 from the head 120 to the skirt 124 in the longitudinal direction of the insulator 100. With this construction, the sheds 130 increase a surface distance along the exterior surface 180 of the insulator 100 from the head 120 to the skirt 124, which increases a creep distance for electrical loading between the line 102 and the pin 104. As such, the sheds 130 reduce a minimum height of the shell 114 for maintaining a sufficient creep distance between the line 102 and the pin 104 for minimizing current leakage from the line 102 to the pin 104.

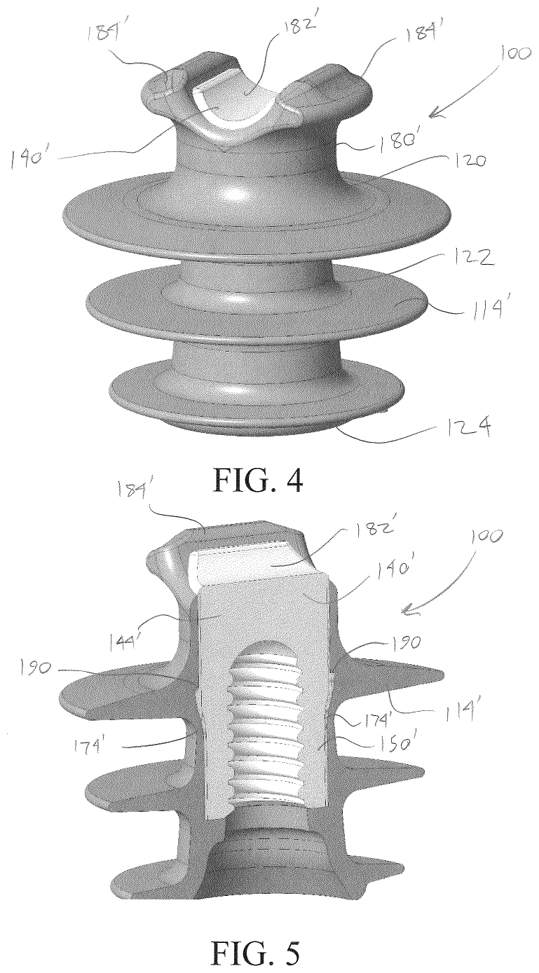

FIG. 4-6 depict an alternative embodiment of the insulator 100 of FIG. 1-3. In the embodiment of FIG. 4-6, like elements with the insulator 100 of FIG. 1-3 are denoted with the same reference numerals but followed by a primed suffix (′). FIG. 4 illustrates an embodiment of the insulator 100 where the exterior surface 180′ defining the saddle 182′ is formed from the core 140′. In this regard, the core 140′ forms the head 120′ with the shell 114′, including the exterior surface 180′ defining the saddle 182′. As depicted, the saddle 182′ is concave toward the opening 152′ and configured for directly contacting and supporting the line 102′ spaced from the pin 104′.

The shell 114′ forms the guards 184′ separated by the core 140′ at the saddle 182′, along the exterior surface 180′ in the left-right direction of the insulator 100. In this regard, the saddle 182′ is interposed between the guards 184′ in the left-right direction of the insulator 100. The guards 184′ extend upward from the main body portion 122′, beyond the saddle 182′ in the longitudinal direction insulator 100, and extend outward from the saddle 182′ in the left-right direction.

FIG. 5 depicts a cross-sectional view of the shell 114′ and the core 140′. As shown in FIG. 5, the second end portion 150′ of the core 140′ includes the protrusions 174′ extended radially outward from the core 140′ and into the shell 114′ perpendicular to the longitudinal direction of the insulator 100.

The protrusions 174′ recede inward, perpendicular to the longitudinal direction of the insulator 100, at the first end portion 144′ of the core 140′. In this manner, the protrusions 174′ form steps 190 that face upward in the longitudinal direction of the insulator 100. With this construction, the shell 114′ abuts the steps 190 in the longitudinal direction of the insulator 100, such that the outer surface 142′ of the core 140′ is obstructed from sliding upward in the longitudinal direction of the insulator 100 relative to the shell 114′.

FIG. 6 depicts a perspective view of the core 140'. As shown in FIG. 6, the first end portion 144′ and the second end portion 150′ of the core 140′ are rounded about the longitudinal direction of the insulator 100 and centered on each other. More specifically, the first end portion 144′ and the second end portion 150′ are cylindrical and concentric with each other along the longitudinal direction of the insulator 100.

The first end portion 144′ has a diameter larger than the second end portion 150′. With this construction, the core 140′ is obstructed from moving downward in the longitudinal direction of the insulator 100 relative to the shell 114′, fixing the shell 114′ with the core 140′ in the longitudinal direction. As such, the core 140′ is fixed in the shell 114′, and prevented from sliding or rotating in any direction relative to the shell 114′.

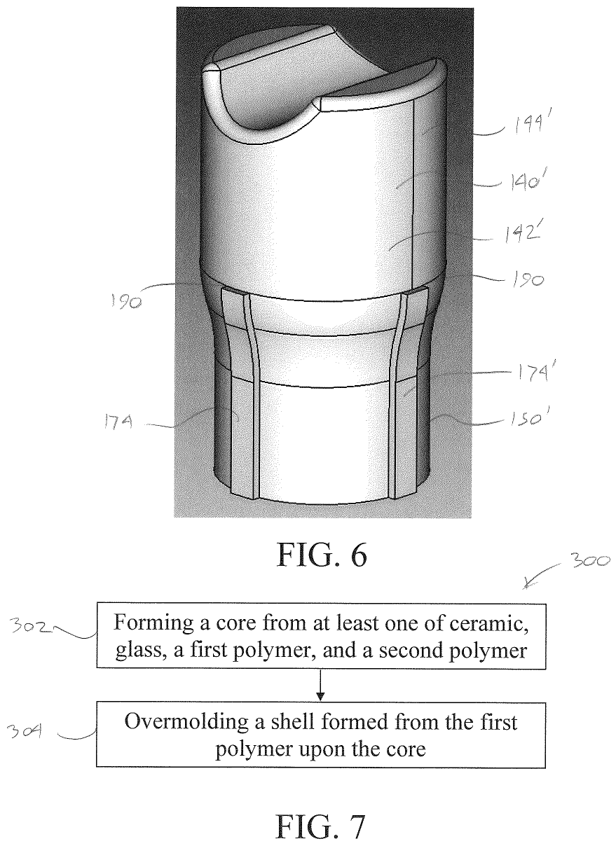

Referring to FIG. 7, a method 300 for manufacturing an insulator that supports a line from a pin will be described according to an example embodiment. FIG. 7 will be described with reference to FIG. 1-3. For simplicity, the method 300 will be described as a sequence of blocks, but the elements of the method 300 can be organized into different architectures, elements, stages, and/or processes.

At block 302, the method 300 includes forming the core 140 from a ceramic, a glass, a first polymer, or a second polymer. In this regard, the core 140 is formed to include the wall 154 that extends in a longitudinal direction of the insulator 100 and defines the threaded opening 152 configured for engaging the pin 104 in a thread fit.

At block 304, the method 300 includes overmolding the shell 114 upon the core 140. In this regard, the shell 114 is formed from the first polymer, and the core 140 or the shell 114 form the head 120 configured to support the line 102 spaced from the pin 104 in the longitudinal direction of the insulator 100.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An insulator that supports a line from a pin, the insulator comprising:
a core that defines an opening configured to receive the pin;
a shell formed from a polymer disposed over an outer surface of the core; and
a head formed from the core or the shell, and configured to support the line spaced from the pin.

2. The insulator of claim 1, wherein the core is formed from an inorganic nonmetal including a ceramic or a glass.

3. The insulator of claim 1, wherein the polymer that forms the shell is a first polymer, and the core is formed from a second polymer different from the first polymer, wherein the first polymer has a lower modulus of elasticity, a higher material strength, or a higher ultimate tensile strength.

4. The insulator of claim 1, wherein the core is formed from the polymer, the core and the shell being cured at different times.

5. The insulator of claim 1, wherein the core includes a first end portion and a second end portion extended from the first end portion in a longitudinal direction of the insulator,
the second end portion defines the opening with a wall extended toward the first end portion in the longitudinal direction, and
the first end portion is larger than the second end portion in a direction perpendicular to the longitudinal direction.

6. The insulator of claim 5, wherein the first end portion is a bulb that defines the outer surface of the core as spheroidal, the second end portion is a stem that defines the outer surface of the core as rounded about the longitudinal direction of the insulator, and the second end portion defines a centerline in the longitudinal direction that intersects the outer surface of the core at the bulb.

7. The insulator of claim 5, wherein the core includes protrusions that extend outward from the second end portion and into the shell in a direction perpendicular to the longitudinal direction of the insulator, and
the protrusions are spaced from the first end portion in the longitudinal direction.

8. The insulator of claim 1, wherein the core forms the head with an exterior surface defining a saddle that is concave toward the opening and configured for directly contacting and supporting the line spaced from the pin.

9. The insulator of claim 8, wherein the core defines the opening with a wall extended toward the head in a longitudinal direction of the insulator,
the shell forms guards separated by the core at the saddle in a direction perpendicular to the longitudinal direction, and
the guards extend beyond the saddle in the longitudinal direction.

10. The insulator of claim 1, wherein the core defines the opening with a wall extended toward the head in a longitudinal direction of the insulator, the shell includes a lip extended along the wall in a direction perpendicular to the longitudinal direction, where the lip abuts and supports the wall at the opening in the longitudinal direction.

11. The insulator of claim 1, wherein the opening is threaded and configured to directly contact the pin in a thread fit for fixing the core and the shell with the pin.

12. The insulator of claim 1, wherein the shell includes a sleeve having a constant wall thickness disposed along the core from the head to the opening.

13. The insulator of claim 1, wherein the shell is overmolded upon the core.

14. The insulator of claim 1, wherein the core defines the opening with a wall extended toward the head in a longitudinal direction of the insulator, and
the shell includes a skirt that extends away from the wall and the head in the longitudinal direction, and outward from the core in a direction perpendicular to the longitudinal direction.

15. The insulator of claim 1, wherein the core defines the opening with a wall extended toward the head in a longitudinal direction of the insulator,
the shell extends around the core perpendicular to the longitudinal direction, and
a thickness of the wall is greater than a thickness of the shell at the wall in a direction perpendicular to the longitudinal direction.

16. An insulator that supports a line from a pin, the insulator comprising:
a core that defines an opening configured for receiving the pin;
a shell overmolded upon an outer surface of the core; and
a head formed from the core and the shell, wherein the core defines a saddle that is concave toward the opening and configured to directly contact and support the line spaced from the pin.

17. The insulator of claim 16, wherein the shell is formed from a polymer, and the core is formed from an inorganic nonmetal including a ceramic or a glass.

18. The insulator of claim 16, wherein the core includes a bulb and a stem extended from the bulb in a longitudinal direction of the insulator,
the bulb has an outer surface that is spheroidal,
the stem has an outer surface that is rounded about the longitudinal direction,
the stem defines the opening with a centerline that intersects the bulb, and
the bulb is larger than the stem in a direction perpendicular to the longitudinal direction.

19. The insulator of claim 16, wherein the core defines the opening with a wall extended toward the head in a longitudinal direction of the insulator,
the shell is disposed entirely around the core, perpendicular to the longitudinal direction,
the shell forms guards separated by the core at the saddle in a direction perpendicular to the longitudinal direction, and
the guards extend beyond the saddle in the longitudinal direction.

20. A method of manufacturing an insulator that supports a line from a pin, the method comprising:
forming a core from a ceramic, a glass, a first polymer, or a second polymer, wherein the core includes a wall that extends in a longitudinal direction of the insulator and defines a threaded opening configured for engaging the pin in a thread fit; and
overmolding a shell upon the core, wherein the shell is formed from the first polymer, and the core or the shell form a head configured to support the line spaced from the pin in the longitudinal direction.
